(19) United States
(12) Patent Application Publication
(10) Pub. No.: US 2026/0046844 A1
(43) Pub. Date: Feb. 12, 2026

(54) CELLULAR RADIO UPLINK PARAMETERS

(71) Applicant: Nordic Semiconductor ASA, Trondheim (NO)

(72) Inventors: Jouni KORHONEN, Oulu (FI); Mauri NISSILÄ, Oulu (FI)

(73) Assignee: Nordic Semiconductor ASA, Trondheim (NO)

(21) Appl. No.: 19/286,018

(22) Filed: Jul. 30, 2025

(30) Foreign Application Priority Data
Aug. 8, 2024 (GB) 2411724.4

(51) Int. Cl. H04W 72/04; H04W 72/52; H04W 72/542

(52) U.S. Cl. CPC H04W 72/04; H04W 72/52; H04W 72/542

(57) ABSTRACT

A method of operating a cellular radio system that comprises a base station and a radio device is disclosed. The method comprises, for a predetermined uplink transmission length and for a predetermined set of uplink resource parameters, the base station transmitting, for receipt by the radio device, a plurality of different sets of values for the uplink resource parameters. The radio device receives the plurality of sets of values and the radio device selects a set of values from the plurality of sets of values. The radio device then transmits a radio packet in accordance with the selected values of the uplink resource parameters.

### CROSS REFERENCE TO RELATED APPLICATION

This application claims priority from United Kingdom Patent Application No. 2411724.4, filed Aug. 8, 2024, which application is incorporated herein by reference in its entirety.

### FIELD

This invention relates to cellular radio systems, radio devices, base stations, and methods for operating the same.

### BACKGROUND OF THE INVENTION

Non-terrestrial networks (NTNs) are wireless communication systems that operate above the Earth's surface, and can bring radio coverage to remote areas that do not have access to traditional terrestrial radio networks. NTNs work similarly to terrestrial networks except that at least one node is based at a high altitude, such as a satellite or a high-altitude platform (e.g. an airship).

It is desirable to enhance the uplink capacity of NTNs. However, current methods can lead to wasted uplink resources and/or restricted radio payload sizes, especially in poor pathloss condition environments.

Embodiments of the present invention seek to provide an approach that allows for a radio base station and radio devices to more efficiently interact in cellular (e.g. NTN) radio systems.

### SUMMARY OF THE INVENTION

From a first aspect, the invention provides a method of operating a cellular radio system comprising a base station and a radio device, the method comprising, for a predetermined uplink transmission length and for a predetermined set of uplink resource parameters:
the base station transmitting, for receipt by the radio device, a plurality of different sets of values for the uplink resource parameters;
the radio device receiving the plurality of sets of values;
the radio device selecting a set of values from the plurality of sets of values;
and
the radio device transmitting a radio packet in accordance with the selected values for the uplink resource parameters.

From a second aspect, the invention provides a radio device for use within a cellular radio system comprising the radio device and a base station, wherein the radio device is configured, for a predetermined uplink transmission length and for a predetermined set of uplink resource parameters, to:
receive a plurality of different sets of values for the uplink resource parameters;
select a set of values from the plurality of sets of values; and
transmit a radio packet in accordance with the selected values for the uplink resource parameters.

From a third aspect, the invention provides a base station for use within a cellular radio system comprising the base station and a radio device, wherein the base station is configured, for a predetermined uplink transmission length and for a predetermined set of uplink resource parameters, to transmit, for receipt by the radio device, a plurality of different sets of values for the uplink resource parameters.

From a fourth aspect, the invention provides a cellular radio system comprising a base station as disclosed herein and a radio device as disclosed herein.

Thus it will be seen that, in accordance with embodiments of the invention, by transmitting a plurality of different sets of values for the uplink resource parameters, the radio device can independently select an optimal set of values for the uplink resource parameters, rather than having to use parameters values specified by the network. This selection could be based on a requirement or property of the radio packet that the radio device is to transmit, such as a payload size of packet, and/or on pathloss conditions between the radio device and the base station (or a relay station, such as a satellite).

The cellular radio system may comprise a cellular network that supports a connection establishment procedure for radio devices. In some embodiments, the transmitting of part or all of the radio packet is performed while the radio device has not established a connection with the cellular network (e.g. not being in an RRC_Connected state, but instead, for example, being in an RRC_Idle state). The transmitting may use an early data transmission (EDT) procedure. In particular, the radio device may be configured to send part or all of the radio packet before receiving a message from the base station indicating that a connection has been established.

The transmitting of part or all of the radio packet may be contention-based.

The radio device may transmit the radio packet for receipt by the base station. The radio device may transmit a plurality of radio packets for receipt by the base station, wherein each radio packet of the plurality is transmitted in accordance with a different respective set of values selected from the plurality of sets of values. These radio packets may be of different sizes and/or be transmitted under different path loss conditions.

The base station may be an eNodeB or a gNodeB in a 4G Long-Term Evolution (LTE) or 5G NR telecommunications network. The base station may be configured to support any current or future 3GPP radio standard. The radio device may support an LTE radio protocol, such as LTE-M. The radio device may support a NarrowBand-Internet-of-Things (NB-IoT) radio protocol.

The base station may be a conventional terrestrial base station that is in direct radio communication with the radio device. However, in preferred embodiments, the base station is a satellite base station, and the radio device communicates with the base station via a satellite. The satellite base station may be a ground-based satellite base station and be configured to communicate with the radio device via a satellite that is distant from the base station, or the satellite base station may be on a satellite. In examples where the base station is ground-based, at least some processing of the received radio packet may be performed by the ground-based base station. In examples where the base station is on a satellite (i.e. in space), at least some processing of the received radio packet may be performed on the satellite.

The base station may be configured to receive a or the radio packet transmitted by the radio device according to the selected values of the uplink resource parameters. It may process part or all of the radio packet to determine which set of values was selected by the radio device for transmitting the radio packet. It may be configured to attempt to decode part or all of the radio packet using each of the sets of values in turn until the radio packet is successfully decoded. The base station may use the determined set of values for further processing the radio packet.

The plurality of different sets of values for the uplink resource parameters may, in some embodiments, total three different sets. It may total more than three different sets. In some embodiments, the base station transmits four different sets. The sets of values may be transmitted to the radio device by radio, encoded in any appropriate way.

The plurality of different sets of values may be stored in a memory of, or accessible to, the base station. They may be preconfigured (e.g. hard-coded) or the base station may generate all of the plurality of different sets of values for the uplink resource parameters (i.e. using an algorithm executing on a processor of the base station). Alternatively, the base station may generate some, but not all, of the plurality of different sets of values for the uplink resource parameters. The base station may receive some or all of the plurality of different sets of values from another node in the radio system (e.g. a gateway or a database node). The plurality of different sets of values may be configured using both the base station and a node external to the base station.

The base station may transmit the plurality of different sets of values to a specific radio device or a specific set (e.g. plurality) of radio devices (e.g. which may be explicitly identified in the transmission), or the base station may broadcast the different sets of values.

The radio device may select the set of values at least in part based on a radio pathloss condition (e.g. by selecting a set that has a repetition parameter that equals or exceeds a repetition value determined from the pathloss condition). The radio device may select the set of values from the plurality of sets of values at least in part based on a size of the radio packet to be transmitted. The radio pathloss condition may be representative of an attenuation of radio signals between the radio device and the base station which may be a satellite, or between the radio device and a satellite relay. This may enable the radio device to select a set of values for the uplink resource parameters that best suits the particular radio packet. In some embodiments, the radio device may select based first on a pathloss condition, and then, if more than one set of values satisfies the pathloss condition, it may then select based on a further condition such as the size of the radio packet.

The radio device may, in use, be configured with a maximum length of a radio packet (i.e. a maximum payload size) which is allowed to be transmitted by the radio device (e.g. in RRC Idle mode using the EDT feature). On occasions it may be desirable for the radio device to transmit a radio packet with the maximum length or with a length of less than the configured maximum length but exceeding a maximum packet length supported by the selected set of values for the uplink resource parameters, or supported by any of the plurality of different sets of values for the uplink resource parameters. The radio device may, in some embodiments, be able to send a radio packet that exceeds a maximum packet length specified by any of the plurality of different sets of values for the uplink resource parameters. This can advantageously improve efficiency, and also allow the radio device to select a set of parameters based foremost on pathloss, even if the selected values do not support the full packet length within a first transmission. In such a scenario, the radio device may be configured to request additional uplink resources from the base station in order to complete transmission of the radio packet. In response, the base station may allocate additional uplink resources to the radio device. The radio device may then perform a further transmission of at least a part of the radio packet in accordance with the further allocated uplink resources. The base station may schedule the further transmission for non-contended transmission. This reduces the risk of radio collisions from transmissions from other radio devices communicating with the network.

In embodiments where the radio device may request additional uplink resources, the base station may be configured to reply to the request from the radio device with a command for the radio device to enter a connected mode (e.g. RRC_Connected) in order to complete transmission of the radio packet. The radio device may leave the connected mode once the radio packet has been transmitted.

All of the plurality of sets of values preferably correspond to the predetermined uplink transmission length.

The base station may transmit the predetermined uplink transmission length to the radio device. The uplink transmission length may indicate a maximum length of a radio packet that the radio device can transmit to the base station, e.g. using any of the received plurality of different sets of values for the uplink resource parameters.

The plurality of different sets of values for the uplink resource parameters may be selected or retrieved by the base station from a database of predetermined values. The database may represent a relationship between uplink resource parameters, such that selecting a value for one uplink parameter restricts what value or values another uplink parameter can take.

The predetermined set of uplink resource parameters may comprise any one or more, or all, of the following parameters: a number of uplink repetitions, a number of uplink resource units, and a transport block size.

The base station may additionally transmit values for one or more additional uplink resource parameters, different from the parameters for which the plurality of sets of values are transmitted. These one or more additional parameters may have respective fixed values across all of the sets. In some embodiments, an additional uplink resource parameter may be a number of uplink slots available for an uplink resource unit. The number of uplink slots available for each resource unit may be dependent on a number of allocated subcarriers and/or a subcarrier spacing supported by the base station.

In any of the aspects disclosed herein, the base station may be a base station of a radio access network. The radio access network (RAN) may comprise a plurality of base stations, some or all of which may be configured as disclosed herein. The cellular radio system may comprise one or more further radio devices, some or all of which may be configured as disclosed herein. The cellular radio system may comprise a packet-switched cellular telecommunications data network. The base station and/or radio device and/or cellular radio network may support a current or future version of the 3GPP LTE (Long Term Evolution) standard, which may include LTE-M and/or NB-IoT.

The radio device and/or base station may comprise any one or more of: processors, memory for storing software instructions, memory having software instructions stored therein, digital logic, analogue circuitry, DSPs, power supplies, user interfaces, sensors, etc. Each may comprise respective cellular-radio circuitry. The radio device may be, or may comprise, an integrated-circuit radio-on-a-chip. The steps described herein as being performed by the base station or by the radio device may be implemented entirely in hardware, or entirely in software, or by a combination of hardware and software, in any appropriate mixture.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram showing a non-terrestrial network (NTN) which embodies the radio system of the present invention;

FIG. 2 is a schematic diagram of an exemplary radio device that is part of a radio system embodying the present invention;

FIG. 3 is a flowchart of a method of operating a radio system embodying the invention;

FIG. 4 is a table showing a relationship between resource unit index and the number of resource units for a radio system embodying the invention;

FIG. 5 is a table showing how resource unit index and transport block size index relate to determine actual transport block size for a radio system embodying the invention;

FIG. 6 is a diagram showing how a single uplink transmission of fixed length is divided up according to the uplink resource parameter values selected in FIG. 5;

FIG. 7 shows the same table as FIG. 5, but with a different selection of uplink resource parameter values;

FIG. 8 is a diagram showing how a single uplink transmission of fixed length is divided up according to the uplink resource parameter values selected in FIG. 7;

FIG. 9 shows the same table as FIGS. 5 and 7, with a different selection of uplink resource parameter values; and

FIG. 10 is a diagram showing how a single uplink transmission of fixed length is divided up according to the uplink resource parameter values selected in FIG. 9.

### DETAILED DESCRIPTION

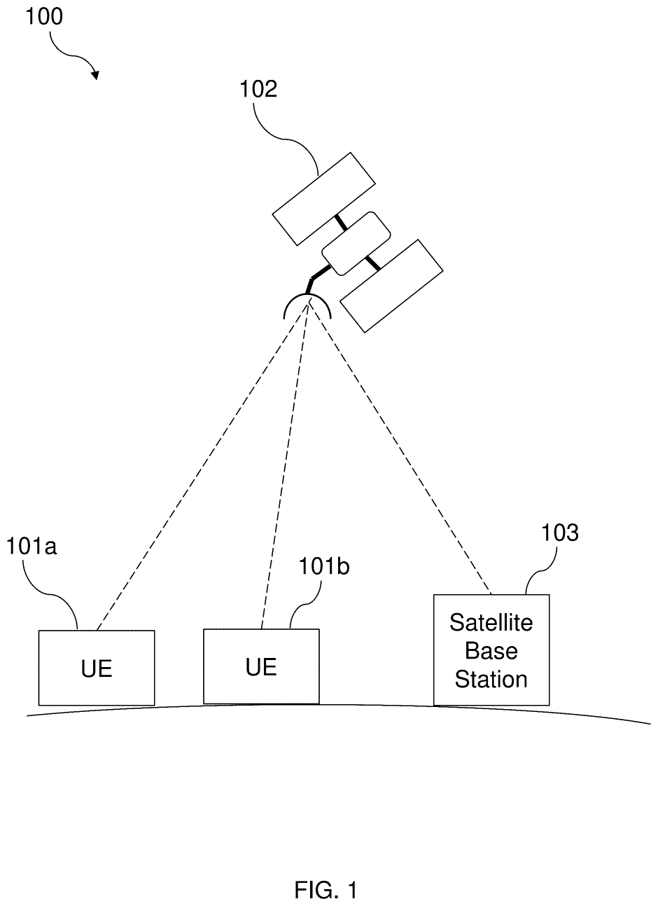

FIG. 1 shows a cellular radio system 100 implementing the invention as disclosed herein. The system 100 includes a number of radio devices 101a, 101b, which are referred to here as user equipment (UE) devices 101a, 101b. The system 100 may support any current or future 4G and/or 5G cellular radio standards. The UE devices 101a, 101b may be 4G LTE or 5G devices, such as LTE-enabled appliances, vehicles, cell phones, etc. They may instead be components within such devices (e.g. respective system-on-chip radios). There may be any number of UE devices in the system 100. Some or all of the UE devices 101a, 101b may be Internet-of-Things (IoT) devices.

The UE devices 101a, 101b are shown in FIG. 1 as being terrestrial (e.g. ground-based or air-borne such as on an aeroplane). They can communicate with other components of the cellular radio system 100 via a satellite 102, which is in orbit. The orbit may be a low Earth orbit (LEO), a medium Earth orbit (MEO), or a geostationary Earth orbit (GEO). The satellite 102 acts as a relay for the system 100, receiving radio packets from the UE devices 101a, 101b and any other devices that are part of the radio system 100. The satellite 102 may contain radio processing modules for processing the received packets. In this example, the satellite 102 relays received radio packets to a ground-based satellite base station 103 for substantive processing. However, in other embodiments, the satellite 102 itself may be a base station (e.g. eNodeB or gNodeB), and be equipped to decode and process received packets accordingly.

In addition to the UE devices 101a, 101b and the satellite 102, the cellular radio system 100 of this example includes a ground-based satellite base station 103, which is able to communicate with UE devices via the satellite 102. The base station 103 acts as a gateway and is connected to a backhaul core network of the cellular radio system 100 (omitted from FIG. 1 for simplicity). Through this, it may provide access to other networks including the Internet. The UE devices 101a, 101b can connect to the Internet by communicating with the base station 103 via the satellite 102. Since the radio system 100 comprises one or more satellites 102 that operate above the surface of the Earth, the radio system 100 comprises a non-terrestrial network (NTN). It will be appreciated that the system 100 may comprise other elements such as high-altitude platforms (e.g. airships, balloons, or other unmanned aerial vehicles), additional UE devices, base stations (some of which may be conventional ground-based base stations) or other gateways, though these have been omitted from FIG. 1 for simplicity.

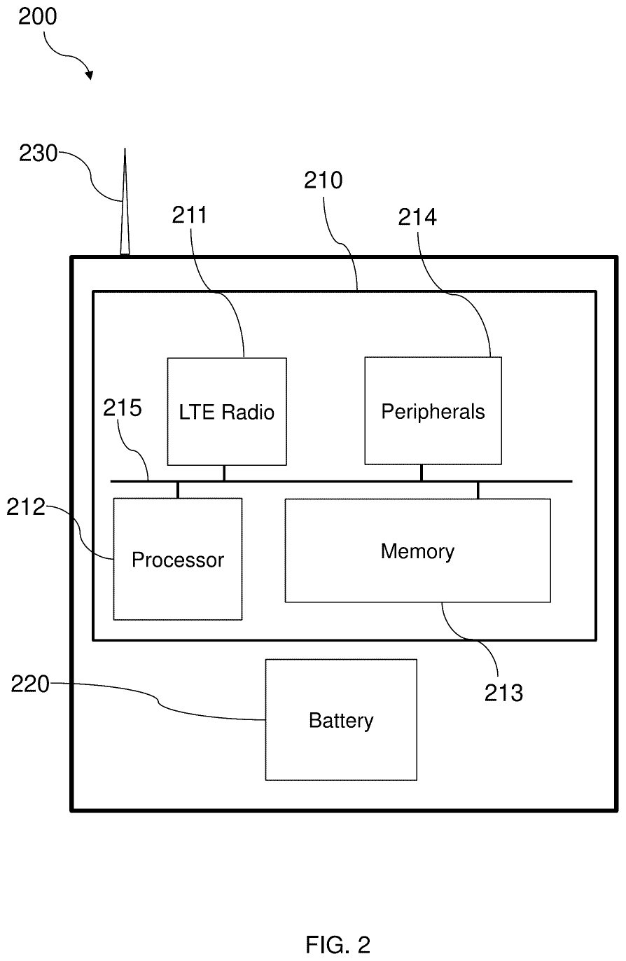

FIG. 2 shows a breakdown of an exemplary radio device 200 and may represent any of the radio devices 101a, 101b that serve as UE devices in the radio system 100. The radio device 200 includes a logic board 210, a battery 220, and a transceiver antenna 230. It will be appreciated that the radio device 200 may contain other discrete components, such as PCBs, oscillators, capacitors, resistors, a housing, user interface features, etc. which are not shown in FIG. 2 for the sake of simplicity.

Turning to the radio device 200 in detail, the logic board 210 includes an LTE radio 211, a processor 212, memory 213 (which may include volatile and non-volatile types), and general peripherals 214 (e.g. timers, digital-to-analogue converters, etc.). These elements are all connected to a bus system 215 which facilitates communication between each module in the logic board 210. In one example, the processor 212 is an Arm processor, although the processor 212 could be any type of processor.

The LTE radio 211 contains digital and analogue logic for implementing some or all of the LTE-M radio protocol and/or the Narrowband-Internet-of-Things (NB-IoT) radio protocol. The radio 211 may also contain conventional components, such as DSPs, amplifiers, etc.

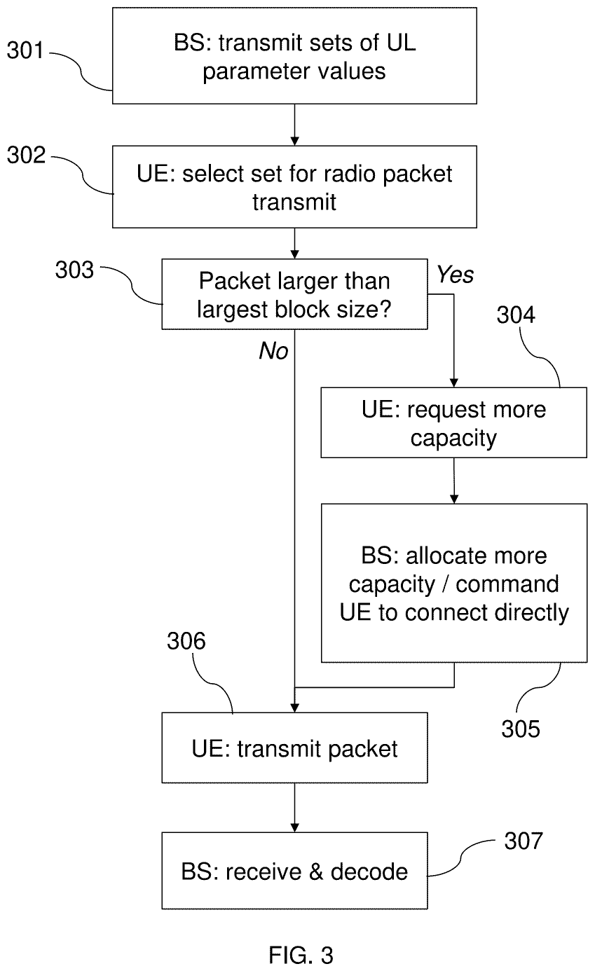

The memory 213 stores software which is executed by the processor 212 for controlling operation of the radio device 200. The software may comprise instructions for implementing part of the method described below with referenced to FIG. 3.

The base station 103 may contain some or all of the same components, or similar components, as the radio device 200. In particular, the base station 103 may have a memory storing software for execution by a processor for implementing one or more of the steps or processes disclosed herein.

The radio device 200 uses the transceiver antenna 230 to send/receive radio transmissions to/from the satellite 102. Received radio packets are passed from the transceiver antenna 230 to the processor 212 to be decoded. Radio packets to be transmitted by the radio device 200 may vary in length considerably and may be required to be transmitted through regions with variable radio signal pathloss conditions. More specifically, the location of the radio device 200 within the radio system 100 will predominately determine the pathloss conditions of any radio packet transmitted by the radio device 200. Based on the pathloss conditions, in order for a radio packet to be correctly received by the satellite 102, there will need to be right number of repetitions within the transmission.

In general, Contention-Based Early Data Transmission (CB-EDT) involves the contention-based transmission of a Radio Resource Control (RRC) connection request (RRC Connection Request or Msg3) using Preconfigured Uplink Resources (PUR) by a radio device (UE). In some examples, it may bypass the exchange of a Random Access Preamble (RAP or Msg1) and Random Access Response (RAR or Msg2) in order to reduce network traffic. Such use of EDT or PUR can improve uplink (UL) capacity in NTNs by reducing the amount of uplink signalling required to complete an EDT transmission. These approaches may be based on implicitly or explicitly reported repetition levels by the UE.

The system 100 may support known EDT mechanisms. However, it additionally implements a novel approach to contention-based early data transmission that enables greater efficiency of uplink resources, especially in poor pathloss condition environments, as described below.

When the radio device 200 is not registered to a cell of the network (i.e. the radio device 200 is not in an RRC_Connected state), the base station 103 may be unaware of the length of radio packets that the radio device 200 wishes to transmit. The base station 103 may also be unaware of the pathloss conditions between the radio device 200 and the satellite 102 and/or base station 103.

In a basic EDT or PUR based approach, a base station may dictate the uplink resources that a UE radio device must use to perform an uplink transmission. In an effort to support as many possible radio packet lengths as possible, the base station may configure uplink resource parameters with values that are cautious to support a wide range of packet lengths, even if very few radio packets in the network use the upper limit of the range. This can be an unnecessary waste of radio resources.

The present system 100 instead allows each radio device 101a, 101b to autonomously adapt the radio link between the device 200 and the satellite 102 and/or base station 103, in a contention-based manner.

In order to facilitate a successful radio packet transmission, the network (i.e. the system 100) must first configure the values of a set of uplink resource parameters. These uplink resource parameters control the behaviour of a radio device 200 when it performs an uplink transmission. Example uplink resource parameters include subcarrier spacing and system bandwidth, but other examples of uplink resource parameters will be discussed in more detail below, including examples in cases where the radio device 200 support NB-IoT. The following description will refer to a specific set of uplink resource parameters, by way of example, but other parameters could be configured within cellular radio systems embodying the invention.

For contention-based UL transmission, basic physical uplink resource parameters defining the size of the LTE UL resource block in time and frequency are broadcasted to all UEs. Such parameters include, for example, a length of the resource block in time and a number of allocated subcarriers and a subcarrier spacing. Additionally, there may be other uplink resource parameters defining an exact structure of the UL transmission within the physical UL resource block. The length of the UL resource block in time is given by the total uplink transmission length N (in milliseconds (ms)). The value of this parameter sets the length (in ms) that a single uplink transmission that is transmitted by the radio device 200 can take. In some examples, this value may be 320 ms, or it may be 640 ms. It may be 10240 ms. In NB-IoT, the total uplink transmission length N may be defined by the expression below in terms of the following uplink resource parameters:

$$N = {N}_{rep} * {N}_{RU} * {N}_{slots}^{RU}$$

where Nᵣₑₚ is the number of uplink repetitions, N_{RU} is the number of uplink resource units, and Nₛₗₒₜₛ^{RU} is the number of uplink slots per resource unit. The length of one uplink slot may be e.g. 1 ms or 2 ms.

Nᵣₑₚ, being the number of uplink repetitions, is the number of times data is repeated within a single uplink transmission. For environments where radio conditions are poor (i.e. high signal attenuation so high pathloss conditions), the value of Nᵣₑₚ should be higher to ensure that the radio signal reaches its destination at the base station 103. For environments where radio conditions are better, the value of Nᵣₑₚ can be lower.

N_{RU} is the number of uplink resource units within the single uplink transmission. In NB-IoT, the resource unit is the basic uplink unit and contains N^{UL}_{symb}*Nₛₗₒₜₛ^{RU} consecutive symbols in the time domain. N^{UL}_{symb} represents the number of symbols in an uplink slot, and Nₛₗₒₜₛ^{RU} represents the number of consecutive slots in an uplink resource unit.

Nₛₗₒₜₛ^{RU} is the number of uplink slots per resource unit, and its value depends on the number of allocated subcarriers and subcarrier spacing (which is usually 3.75 kHz or 15 kHz, though it will be understood that other values of subcarrier spacing may be used).

Another uplink resource parameter that may be configured by the system 100 is the transport block size (TBS). The transport block contains the data payload that is transmitted from the radio device 200 to the base station 103, via the satellite 102. The TBS can take many values, and may be, for example, 1000 bits. The value that the TBS can take may depend on the number of uplink resource units N_{RU}.

In the present embodiments, the value of N is fixed, along with the value of Nₛₗₒₜₛ^{RU}. Nₛₗₒₜₛ^{RU} is fixed due to the frequency allocation of the uplink resources, i.e., it is determined by the number of subcarriers allocated for the contention-based UL resource block. Whilst these values are fixed, the values of Nᵣₑₚ, N_{RU}, and TBS can vary for a given uplink transmission so long as the fixed value of N is preserved. In order to ensure that this is enforced, the base station 103 stores a plurality of different sets of predetermined uplink resource parameter values that combine to produce the same value of N. In some examples, these different sets of predetermined uplink resource parameter values are configured by the base station 103 directly. In other examples, the different sets of uplink resource parameter values are predetermined by a node external to the base station 103, and then communicated to the base station 103.

As mentioned above, from a network capacity perspective, it is a waste of uplink resources to configure values of the predetermined uplink resource parameters which are long enough to accommodate radio devices with a maximum allowed payload but very poor pathloss conditions at the edge of an NTN radio cell. Instead, the different predetermined sets of uplink resource parameter values are determined such that the majority of UEs within the cellular radio system 100 can transmit a radio packet in a single uplink transmission. In the event that a radio device needs to transmit a packet that has a payload size less than the maximum allowed TBS but larger than what can fit into the predetermined UL resource block, for example due to a large number of UL repetitions needed for the transmission in poor radio conditions, the radio system 100 can accommodate such exceptions, as will be discussed in more detail below.

Once the base station 103 has stored the different sets of predetermined uplink resource parameter values, the base station 103 can transmit each set within the wider radio system 100. This may be done (via the relay satellite 102) in a targeted manner (e.g. to a specific geographical region, or a specific cluster of UEs, or a single identified UE), or it may be a broadcast transmission that may be received by any radio devices in range—e.g. broadcast within SIB1 or SIB2 shared signalling, or communicated to a UE when the UE is released to idle mode. The base station 103 may also transmit the total uplink transmission length N, and may transmit other radio uplink parameters, such as radio quality thresholds. These quality thresholds may be used by the UE 101a, 101b to select an appropriate physical uplink resource block, if the base station has configured a number of such resource blocks, each having e.g. a different total transmission length N.

The radio devices 101a, 101b receive the transmitted sets of predetermined uplink resource parameter values. The radio devices 101a, 101b are not fully connected to the base station 103 (i.e. not in RRC_Connected state). Based on the radio device 101a, 101b determining the size of the radio packet to be transmitted, along with the local radio pathloss conditions, the radio device 101a, 101b, selects a single set of predetermined uplink resource parameter values for transmitting a radio packet. In some embodiments, the radio device 101a, 101b will favour a set of uplink resource parameter values that contains a smallest number of repetitions appropriate for a determined pathloss. If multiple sets of values meet this criterion, it may then additionally select based on payload size. In cases where the payload is too large for the resulting uplink transmission length defined by any of the sets of values satisfying a pathloss condition, the radio device may request additional uplink resources, as described below.

Allowing the radio device 101a, 101b to select the uplink parameters used to transmit the radio packet ensures efficient packet transmission without dedicated signalling. This reduces overall radio traffic in the radio system 100, and improves the efficiency with which a given radio device 101a, 101b can transmit a radio packet of a certain size.

Once the radio device 101a, 101b has selected a predetermined set of uplink resource parameter values to transmit a radio packet, the radio device 101a, 101b transmits the radio packet according to those selected values to the base station 103.

The base station 103 receives the transmitted radio packet (relayed by the satellite 102), but since it was the radio device 101a, 101b that selected the set of values for the uplink resource parameters, the base station 103 cannot decode the radio packet until it has determined what parameters values were used. Instead, the base station 103 uses the stored different sets of predetermined uplink resource parameter values, in combination with the received radio packet, to determine which set of values was selected by the radio device 101a, 101b. The base station 103 may perform this blind detection by considering a portion of the received packet (potentially before the whole packet has been received). For example, as soon as it receives signal samples corresponding to a shortest possible length, it may attempt to decode the received samples against each of the sets of parameter values in turn. If the decoding fails for every set of values, it may wait to receive more samples and then try again. Where the packet repeats, the base station 103 may be able to stop early if it has successfully decoded the packet without needing all of the repetitions. In some examples, each set of parameters may have a different value for one of the parameters (e.g. TBS); in this case, if the base station 103 can correctly identify the value for TBS used by the radio device 101a, 101b, then the base station 103 may be able to determine which set of uplink parameter values was used by the radio device 101a, 101b from this, and attempt to decode the whole radio packet.

Considering now in more detail when the radio device 101a, 101b receives the different sets of predetermined uplink resource parameter values, the radio device 101a, 101b may find that the size of the radio packet it needs to transmit is greater than any TBS that is specified in the transmitted sets of parameter values from the base station 103. In this scenario, the radio device 101a, 101b is configured to request, as part of an initial transmission to the base station 103, additional dynamically scheduled uplink resources to transmit the remaining bits of the radio payload. The base station 103 can respond in one of two ways. The base station 103 can either schedule the requested additional uplink resources to the radio device 101a, 101b, or can command the radio device 101a, 101b to transfer to an RRC Connected mode. In the RRC Connected mode, the radio device 101a, 101b expends more energy maintaining a constant connection to the base station 103, but the connection is non-contended and able to support the reliable transmission of much larger radio packets compared to sending a radio packet using Msg3 according to a selected set of uplink resource parameter values as described above. When the radio device 101a, 101b is in the RRC Connected mode, the radio device 101a, 101b is scheduled by the base station 103 for dedicated uplink transmissions.

The following discussion will describe the operation of the radio system 100 embodying the present invention with reference to FIG. 3. FIG. 3 is a flowchart showing a method for operating the cellular radio system 100 according to an embodiment of the present invention. At step 301, the base station (BS) 103 (via the satellite 102) transmits (e.g. broadcasts) a plurality of different sets of predetermined uplink resource parameter values for receipt by the radio device 101a, 101b (also referred to as the UE 101a, 101b). As mentioned above, these different sets of predetermined uplink resource parameter values will comprise values for Nᵣₑₚ, N_{RU}, and TBS, and the values may be configured directly by the base station 103, or may be received externally from another node in the radio system 100. The number of different sets of uplink resource parameter values that are transmitted by the base station 103 may vary, and may be dependent on radio conditions of the system 100. In the following example, four different sets of uplink resource parameter values are transmitted for receipt by the UEs 101a, 101b, but it will be appreciated that the base station 103 may transmit more than this (e.g. five or more different sets), or less (e.g. three sets).

At step 302, the UE 101a, 101b selects a single set of predetermined uplink resource parameter values to use for transmitting a radio packet. The UE 101a, 101b may determine which set of uplink parameter values it selects based on the size of the radio packet that needs to be transmitted. In addition, or alternatively, the UE 101a, 101b, may determine which set it selects based on information related to the radio pathloss conditions local to the UE 101a, 101b and the base station 103. This pathloss information may be determined directly by the UE 101a, 101b by measuring the received signal power level of known reference signals transmitted by the base station 103, or the UE 101a, 101b may receive pathloss condition information from the base station 103. If the base station 103 provides pathloss information to the UE 101a, 101b, this information may be provided alongside the sets of uplink parameter values (i.e. as part of the same transmission) or it may be provided separately from the sets of uplink resource parameter values (i.e. as part of a separate transmission).

At step 303, the UE 101a, 101b determines if the size of the packet it needs to transmit is larger than it can transmit, under the current radio channel conditions, using the allowed transport block sizes in a set of the predetermined uplink resource parameter values that are transmitted by the base station 103 to the radio device 101a, 101b. If the packet is smaller, then the UE 101a, 101b is able to make use to the allocated uplink resources to transmit the packet to the base station 103. The transmission of the radio packet happens in step 306.

However, if the radio packet is larger than any of the available predetermined TBS that the UE 101a, 101b can transmit in a given situation, then the UE 101a, 101b, at step 304, will choose an optimal set of predetermined uplink resource parameter values, and transmit a portion of the radio packet to the base station 103. Alongside the transmission of the radio packet portion is a request for more uplink resources to be provided to the UE 101a, 101b from the base station 103. The payload that the UE 101a, 101b needs to transmit is therefore divided into a number of smaller transport blocks (with a TBS smaller than the maximum allowed TBS) and each of those transport blocks is separately transmitted by the UE 101a, 101b and independently decoded by the base station 103.

At step 305 the base station 103 can, in response to the request from the UE 101a, 101b for more uplink resources, perform one of two actions. In one case, the base station 103 can respond to the UE 101a, 101b by dynamically allocating more uplink resources to the UE 101a, 101b. The additional resources provided to the UE 101a, 101b allow it to complete the transmission of the radio packet to the base station 103. In the second case, the base station 103 can command the UE 101a, 101b to transition into a fully connected mode (e.g., RRC-Connected mode). In the fully connected mode, the UE 101a, 101b has access to enough uplink resources to complete the transmission of the radio packet.

It will be appreciated that if the radio packet can be transmitted within the predetermined different TBS values contained within the transmitted sets of uplink parameter values, then steps 304 and 305 are skipped, and the UE 101a, 101b proceeds to step 306 where the packet is transmitted to the base station 103.

At step 306, the UE transmits (or completes transmission of) the radio packet to the base station 103.

At step 307, the base station 103 receives the incoming radio packet. The base station 103 does not know which set of values was selected by the UE 101a, 101b for transmitting the radio packet. As such, in order to decode the radio packet, the base station 103 performs a set of steps to determine which set of uplink resource parameter values was selected by the UE 101a, 101b. This is done without any prior knowledge of the packet, and so can be considered an example of blind detection. Example methods used by the base station 103 to perform such a blind detection have been described in more detail above. The packet can then be decoded and its content processed appropriately by the base station 103 and/or other network components.

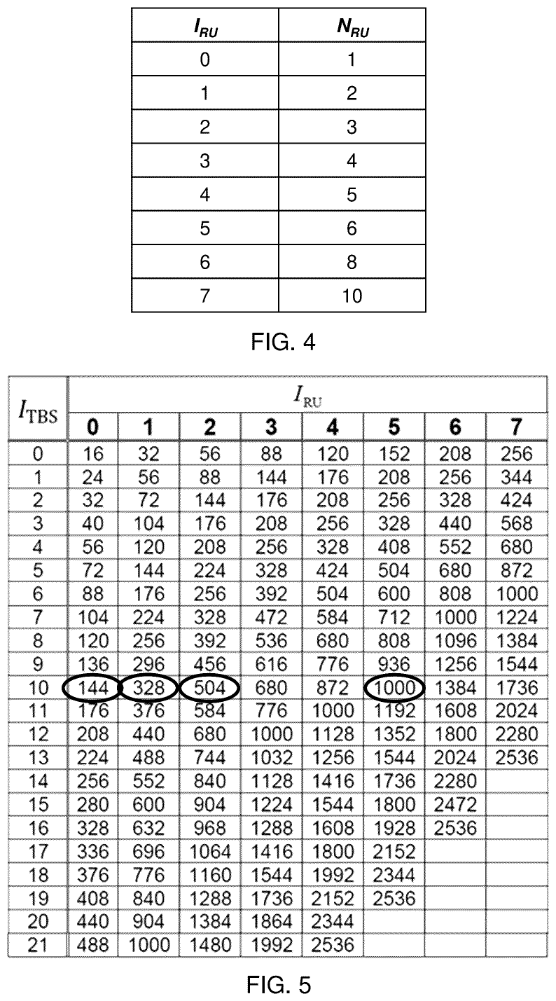

Some examples of the different sets of predetermined uplink resource parameter values will now be considered with reference to FIGS. 4-10. FIG. 4 shows a table mapping a resource unit index (I_{RU}) from zero to seven to the uplink parameter representing the number of resource units (N_{RU}). The table of FIG. 4 will be used in conjunction with FIGS. 5-10 to determine which values of given uplink resource parameters can be used for a given set.

FIG. 5 shows a table that provides the transport block size (in bits) according to the selected resource unit index (I_{RU}) and the selected transport block size index (I_{TBS}). Four examples are shown in the figure as indicated by the circled values, giving TBS sizes of 144, 328, 504, and 1000 for specific values of resource unit index (I_{RU}). Thus, by using these values for transport block sizes, the resulting number of resource units can be determined using the table of FIG. 4. It should be noted that the same value of TBS occurs more than once in FIG. 5 (though in this example different values of TBS were selected), since the same TBS can be achieved with different numbers of resource units depending on the coding rate used. The same TBS applied to different numbers of resource units gives different coding rates for the transport block. For example, by reducing the coding rate a bigger resource unit index can be selected. For a smaller coding rate the number of redundant bits within a coded transmission block is increased, thus providing an implicit means of repetition. In addition, there may be explicit repetitions given by Nᵣₑₚ parameter.

Based on the exemplary selections of TBS in FIG. 5, application of FIG. 4, and the knowledge that the values for N and Nₛₗₒₜₛ^{RU} are fixed, it will be appreciated that the configuration of uplink resource parameter values (Nᵣₑₚ, N_{RU}, TBS) is:
(4, 6, 1000)
(8, 3, 504)
(12, 2, 328)
(24, 1, 144)

These four sets of predetermined uplink resource parameter values can then be transmitted by the base station 103 to be received by a UE 101a, 101b that is in range of the satellite 103 associated with the satellite base station 103.

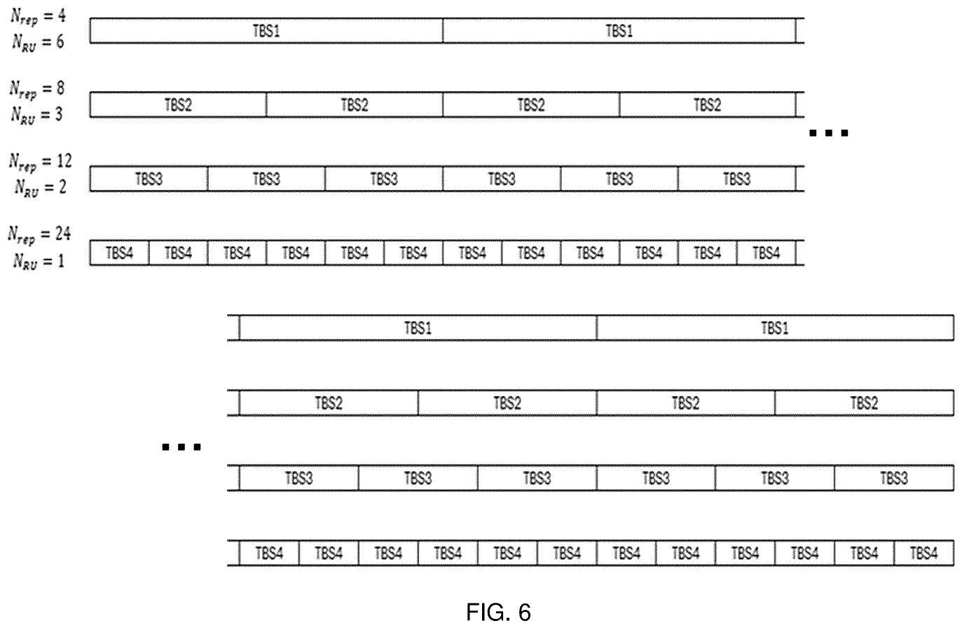

FIG. 6 shows how an uplink data packet is divided up according to the predetermined uplink resource parameter values from FIGS. 4 and 5. The length of each packet is the total uplink transmission length N, and the division of each packet is represented in the time domain. Thus, it can be seen that the largest TBS value of 1000 in this example is repeated four times with six resource units, and the smallest TBS value of 144 is repeated 24 times with one resource unit.

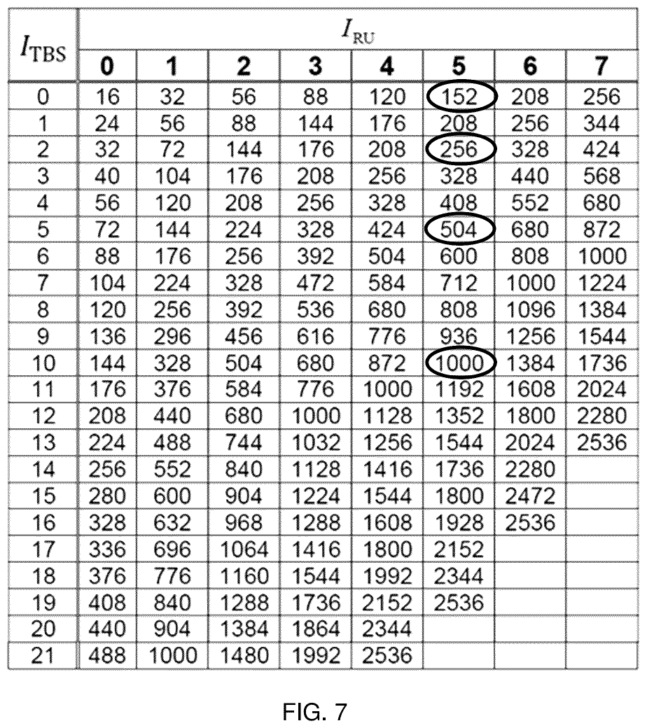

FIG. 7 shows the same table as shown in FIG. 5, but with a different set of selected TBS parameter values. In this example, for each set the same number of resource units has been selected (I_{RU} is five, therefore N_{RU} is 6 according to FIG. 4).

For the same predetermined uplink transmission length N, this results in the following different sets of predetermined uplink resource parameter values:
(4, 6, 152)
(4, 6, 256)
(4, 6, 504)
(4, 6, 1000).

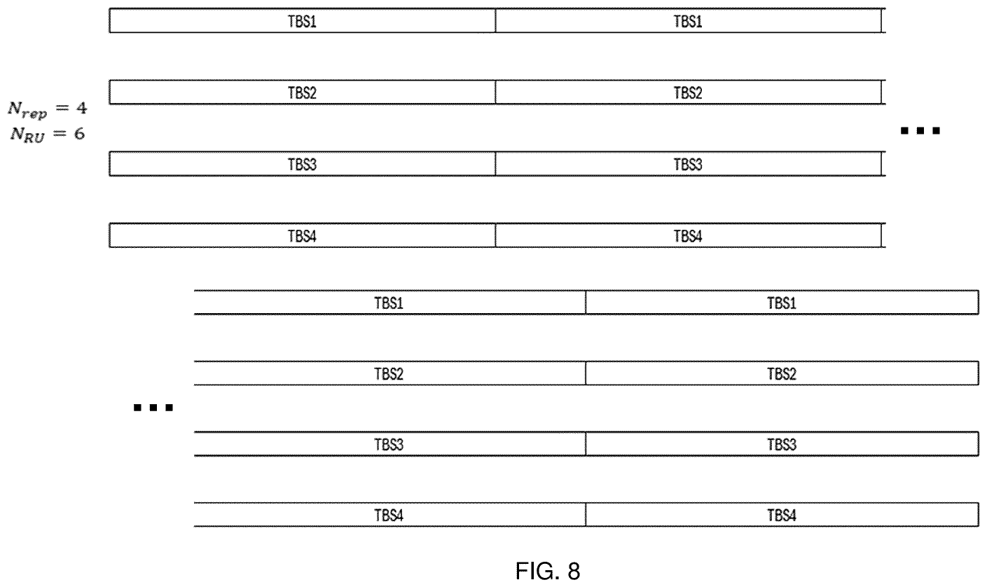

FIG. 8 shows how an uplink data packet of length N is divided according to each set of predetermined uplink resource parameter values selected from FIG. 7. Since only the TBS value varies for each set of values in this example, each TBS is repeated four times with six resource units. If the UE 101a, 101b received these sets of parameter values, then the UE 101a, 101b would use the local radio pathloss conditions to determine which set of parameter values it selects. If the path loss conditions are poor, then the UE 101a, 101b will favour a smaller TBS.

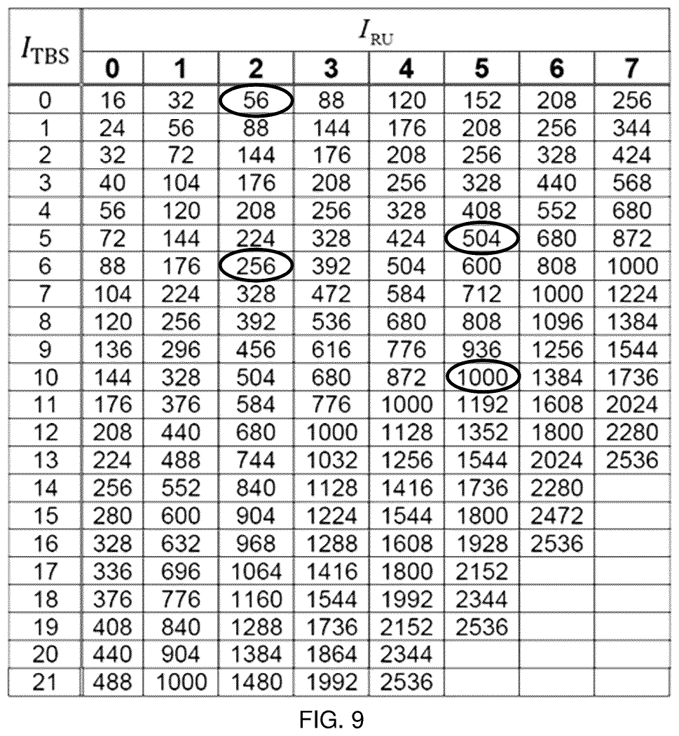

FIG. 9 shows the same table of FIG. 5 with yet another different set of selected TBS values. In this examples, four different TBS values are highlighted for two different values of resource unit index (I_{RU}). The transmitted sets of uplink resource parameter values in this example (by using FIG. 4) is therefore:
(8, 3, 56)
(8, 3, 256)
(4, 6, 504)
(4, 6, 1000).

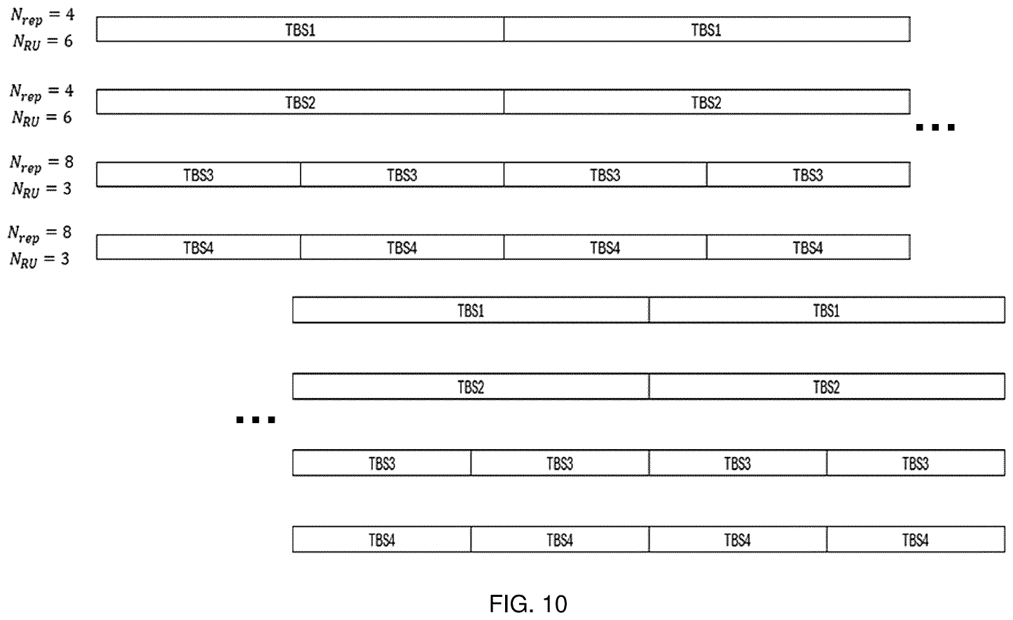

FIG. 10 shows how an example uplink packet of length N is divided up according to the predetermined uplink resource parameter values resulting from the example given in FIG. 9. As can be seen in FIG. 10, two example sets have the TBS being repeated four times with six resource units over the total uplink transmission length N, and two further examples have eight repetitions of the TBS with three resource units.

A more detailed description of how multiple uplink transmissions, in the scenario where the radio packet from the UE 101a, 101b cannot be fully transmitted in one transmission, is now provided. The following steps may be followed:
1) An indication in broadcast signalling (e.g. SIB2-(NB)) that multiple transmissions for CB-EDT is supported. This indication can be done using either
   a. an explicit capability bit (i.e. a Boolean indicator)
   b. a mandatory configuration parameter that the UE 101a, 101b can use to determinate and the base station 103 can use to indicate the support for multiple uplink transmissions.
2) An information element is used to define the maximum amount of data the UE 101a, 101b can send using the multiple transmissions (in bytes).
3) The UE 101a, 101b is allowed to use multiple transmissions if the UE 101a, 101b has less than the indicated maximum amount of data to transmit and has a valid TA (Timing Advance).
4) An alternative option for indicating the support of multiple uplink transmissions includes the UE 101a, 101b using an indication bit/Boolean (must be a single bit in some cases) in the “initial” CCCH message to indicate that the UE 101a, 101b wants to send more than a single uplink transmission to accommodate the radio packet using either:
   a. RRCConnectionResumeRequest(-NB)
   b. RRCEarlyDataRequest(-NB)
5) Instead of just a single Boolean indication, the UE 101a, 101b may include a BSR MAC CE in the “initial” CCCH message with the number of bytes the UE 101a, 101b wants to send. This serves as an indication that the UE 101a, 101b needs to send more than a single uplink transmission.
   a. The UE 101a, 101b can use the BSR MAC CE in subsequent transmissions to indicate the need for more uplink resources if necessary.
6) If the base station 103 accepts multiple transmissions from the UE 101a, 101b the base station 103 will provide the UE 101a, 101b with further uplink resources.
   a. The base station 103 send a UE 101a, 101b a Contention Resolution Identity MAC CE.
   b. The base station 103 also sends a new CB-EDT-RNTI MAC CE that contains the RNTI to be used during subsequent transmissions.
   c. The UE 101a, 101b continues to transmit uplink data and includes a BSR MAC CE into each transmission. The base station 103 uses the BSR information to determine when the UE 101a, 101b is done with its transmissions.
   d. The base station 103 ends the transaction.
   e. UE 101a, 101b and base station 103 discard the CB-EDT-RNTI.
7) If the base station 103 rejects multiple transmissions from the UE 101a, 101b the base station 103 may move the UE 101a, 101b into an RRC_CONNECTED mode by responding the UE 101a, 101b with an RRCConnectionSetup(-NB) message (Msg4).
   a. In this case the Msg4 also contains contention resolution information.
   b. If the contention resolution was successful for the UE 101a, 101b it can assume the data sent in the “initial” transmission is successfully received and there is no need to retransmit it.
   c. The base station 103 releases the UE 101a, 101b using existing legacy mechanisms.

It will be appreciated by those skilled in the art that the invention has been illustrated by describing one or more specific embodiments thereof, but is not limited to these embodiments; many variations and modifications are possible, within the spirit and scope of the disclosure.

We claim:

1. A method of operating a cellular radio system comprising a base station and a radio device, the method comprising, for a predetermined uplink transmission length and for a predetermined set of uplink resource parameters:
the base station transmitting, for receipt by the radio device, a plurality of different sets of values for the uplink resource parameters;
the radio device receiving the plurality of sets of values;
the radio device selecting a set of values from the plurality of sets of values; and
the radio device transmitting a radio packet in accordance with the selected values of the uplink resource parameters.

2. The method of claim 1, wherein the cellular radio system comprises a cellular network and wherein the radio device transmits part or all of the radio packet while the radio device is not connected with the cellular network.

3. The method of claim 1, wherein the radio device transmits a plurality of radio packets for receipt by the base station, wherein each radio packet is transmitted in accordance with a different respective set of values selected from the plurality of sets of values.

4. A radio device for use within a cellular radio system comprising the radio device and a base station, wherein the radio device comprises digital logic and analog circuitry and is configured, for a predetermined uplink transmission length and for a predetermined set of uplink resource parameters, to:
receive from the base station a plurality of different sets of values for the uplink resource parameters;
select a set of values from the plurality of sets of values; and
transmit a radio packet in accordance with the selected values for the uplink resource parameters.

5. The radio device of claim 4, further configured to select the set of values from the plurality of sets of values at least in part based on a radio pathloss condition.

6. The radio device of claim 4, further configured to select the set of values from the plurality of sets of values at least in part based on a size of the radio packet to be transmitted.

7. The radio device of claim 4, further configured to select the set of values from the plurality of sets of values based first on a radio pathloss condition, and then, if more than one set of values satisfies the pathloss condition, based additionally on a size of the radio packet to be transmitted.

8. The radio device of claim 4, further configured to transmit part or all of the radio packet using contention-based transmission.

9. The radio device of claim 4, further configured, when the radio packet to be transmitted exceeds a maximum packet length specified by the selected set of values, to request additional uplink resources from the base station in order to complete transmission of the radio packet.

10. The radio device of claim 9, further configured, after additional uplink resource parameters have been allocated to the radio device by the base station, to perform a further transmission of at least a part of the radio packet in accordance with the further allocated uplink resources.

11. The radio device of claim 10, further configured to transmit the part or all of the radio packet in accordance with the further allocated uplink resources using non-contended transmission.

12. The radio device of claim 4, wherein the predetermined set of uplink resource parameters comprises any one or more, or all, of the following parameters: a number of uplink repetitions, a number of uplink resource units, and a transport block size.

13. A base station for use within a cellular radio system comprising the base station and a radio device, wherein the base station comprises a memory configured to store, for a predetermined uplink transmission length, a plurality of different sets of values for a predetermined set of uplink resource parameters, and wherein the base station is configured, for the predetermined uplink transmission length and for the predetermined set of uplink resource parameters, to transmit, for receipt by the radio device, the plurality of different sets of values for the uplink resource parameters.

14. The base station of claim 13, wherein the base station is a satellite base station.

15. The base station of claim 13, wherein all of the plurality of sets of values correspond to the predetermined uplink transmission length.

16. The base station of claim 13, further configured to transmit the predetermined uplink transmission length to the radio device.

17. The base station of claim 13, further configured, in response to receiving a radio packet transmitted by the radio device in accordance with a set of values for the uplink resource parameters selected by the radio device from the plurality of different sets of values, to process part or all of the radio packet to determine which set of values was selected by the radio device for transmitting the radio packet.

18. The base station of claim 17, configured to attempt to decode part or all of the radio packet using each of the sets of values in turn until the radio packet is successfully decoded.

19. The base station of claim 13, configured, in response to receiving a request from the radio device for additional uplink resources, to allocate additional uplink resources to the radio device.

20. A cellular radio system comprising the radio device of claim 4 and a base station, wherein the base station comprises a memory configured to store, for the predetermined uplink transmission length, a plurality of different sets of values for the predetermined set of uplink resource parameters, and wherein the base station is configured, for the predetermined uplink transmission length and for the predetermined set of uplink resource parameters, to transmit, for receipt by the radio device, the plurality of different sets of values for the uplink resource parameters.
